(19) United States
(12) Patent Application Publication
(10) Pub. No.: US 2016/0068123 A1
(43) Pub. Date: Mar. 10, 2016

(54) Method and Device for Communication Between a Transmitter and a Vehicle

(71) Applicant: VOLKSWAGEN AKTIENGESELLSCHAFT, Wolfsburg (DE)

(72) Inventors: Lennart Helmhold, Braunschweig (DE); Michael Klaas, Schwülper (DE); Simon Gerlach, Hannover (DE)

(73) Assignee: VOLKSWAGEN AG, Wolfsburg (DE)

(21) Appl. No.: 14/786,662

(22) PCT Filed: Mar. 7, 2014
(86) PCT No.: PCT/EP2014/054457

§ 371 Date: Oct. 23, 2015

(30) Foreign Application Priority Data
Apr. 23, 2013 (DE) 10 2013 007 055.4

(51) Int. Cl. B60R 16/037; H04W 4/14; G01C 21/34

(52) U.S. Cl. CPC B60R 16/037; G01C 21/34; H04W 4/14

(57) ABSTRACT

A method for communication between a transmitter and a vehicle includes transmitting information in the form of a text message in machine-readable form from the transmitter to the vehicle, receiving and analyzing the information of the vehicle, and automatically executing an application of the vehicle as a function of the information. A device by which the method of the invention may be implemented is also described.

### FIELD OF THE INVENTION

The present invention relates to a method and a device for communication between a vehicle and a transmitter, for example, a further vehicle.

### BACKGROUND OF THE INVENTION

Conventional infotainment systems of vehicles offer the opportunity of transmitting vehicle data, for instance via social networks. For example, this makes it possible to send a message such as “I am in Munich and it is 10° C.” without any special effort.

In addition, navigation applications are available, such as for the iPhone, by which arrival data can be transmitted via social networks with the aid of messages.

Vehicle fleet operators or commercial vehicles transmit vehicle data to a back end, where processing or an analysis of these vehicle data will then be carried out.

The publication US 2010/0123737 A1 describes the transmission of a location in the form of an URL from a mobile device to another mobile device by email or SMS.

The publication US 2012/0225677 A1 describes the synchronization of information between a mobile device and a vehicle.

It is an object of the present invention to improve the communication between a transmitter and a vehicle to the effect that an item of information transmitted to the vehicle by the transmitter is able to be utilized further in a manner that is simpler than in the related art, especially in order to lower operating and device costs for the vehicle manufacturer.

### SUMMARY

An example embodiment of the present invention relates to a method for the communication between a vehicle and a transmitter. In an example embodiment of the present invention, the transmitter is inside a further vehicle. The communication method according to an example embodiment of the present invention includes the following steps:
Transmitting information in the form of a text message, the information being provided (at least partially) in machine-readable form, from the transmitter (e.g., a mobile radio transmitter, Internet server) to the vehicle. The text message is transmitted in particular via a standard communications mechanism (e.g., SMS, iMessage, Twitter, email, Facebook, Instant Messenger such as WhatsApp, ICQ, etc.) from the transmitter to the vehicle by way of a mobile radio network. The text message, the transmission of which is usually initiated by a vehicle occupant, may also include information that can be understood by a person.
Receiving and analyzing the information of the vehicle. The vehicle receives the information and analyzes the information in order to then process it further.
Automatically executing an application of the vehicle as a function of the information. In particular, a certain application of the vehicle (e.g., starting the navigation system, opening the hood, or selecting a radio station) is determined and carried out on the basis of the information. The execution of the application may additionally be performed as a function of a positive confirmation, such as by the driver of the vehicle.

The communication method according to example embodiments of the present invention may include:
According to an example embodiment of the present invention, the text message is transmitted and received with the aid of a mobile radio device (e.g., smartphone), which is coupled to the vehicle for communication purposes via a data channel and intrinsically supports the standard communications mechanism, e.g., by corresponding applications. The data channel may in turn be based on proprietary technologies.
According to an example embodiment of the present invention, the vehicle itself includes a communications device and thus is able to communicate on its own with a mobile radio device outside the vehicle or a further communications device of a further vehicle.

The communications method according to an example embodiment of the present invention advantageously makes it possible for the vehicle to automatically further process the information transmitted by the transmitter to the vehicle in the form of a text message (e.g., with the aid of the mobile radio device). In this way, for example, the driver of the vehicle does not have to take the corresponding information from the text message in order to then input it manually into the infotainment system of the driver's vehicle, for example, where the information is then processed further in the appropriate manner.

According to an example embodiment of the present invention, the information may include a location (e.g., in the form of geographic coordinates), which is automatically stored in a navigation system of the vehicle. Depending on this location information, a route will then be ascertained for the vehicle according to this example embodiment.

For instance, an example embodiment of the present invention makes it possible to transmit the current location or the destination set in the navigation system of the further vehicle to the vehicle from a further vehicle and that the navigation system of the vehicle automatically ascertains a route for the vehicle to this location (possibly after confirmation by the driver).

According to an example embodiment of the present invention, the information includes station information of a radio station. After receipt of the text message, the appropriate radio station is selected in a radio of the vehicle (possibly after confirmation by the driver).

An example embodiment of the present invention allows the driver of a further vehicle to transmit his currently selected radio station to the vehicle in the form of a text message, and the radio system of the vehicle to automatically select the same station.

In an example embodiment of the present invention, a method for transmitting the information of a vehicle is provided, comprising the following steps:
Acquiring the information of the vehicle or a certain device of the vehicle.
Encoding the information in machine-readable form into a text message. In particular, the information is stored in the text message, which is basically also readable by persons, in such a way that the information is able to be detected by a machine or automatically gathered from this text message.
Transmitting the text message via a mobile radio network.

The method for transmitting according to an example embodiment of the present invention may be implemented as an application or as applications in a mobile radio device (smartphone), for instance, which is coupled to the vehicle or a certain device of the vehicle in a manner that enables a communication. As a result, the vehicle or a certain device of the vehicle may merely provide the information, while the encoding and the transmission of the information in the form of the text message may be implemented by the mobile radio device.

The encoding of the information into the text message may be realized with the aid of a hyperlink. To do so, the information is encoded as a hyperlink or into a hyperlink, which is embedded at a certain location in the text message. Moreover, the transmission of the text message may be carried out with the aid of a standard communications mechanism, which is already part of the mobile radio device for other reasons. The method for transmitting according to an example embodiment of the present invention, with the aid of hyperlink technology and with the aid of a standard communications mechanism, has the advantage of employing established mechanisms.

In an example embodiment of the present invention, a method for receiving the information is provided for a vehicle as well. The method for receiving comprises the following steps:
Receiving the text message via a mobile radio network.
Decoding the text message in order to acquire the information stored in machine-readable form within the text message.
Forwarding the information to the vehicle or to a device of the vehicle, so that an application of the vehicle is carried out automatically as a function of the information.

The method for receiving according to an example embodiment of the present invention may also be implemented as an application or as applications of a mobile radio device (smartphone), for instance, which is coupled to the vehicle or a certain device of the vehicle in a manner that allows communication. In this case the vehicle or the corresponding device of the vehicle accepts the information from the mobile radio device in order to activate the application of the vehicle as a function of the information. In this example embodiment of the present invention, it is advantageously not necessary for the vehicle or a device of the vehicle to receive the text message via mobile radio communication and to decode it.

The receiving of the text message via mobile radio communication may be carried out using a standard communications mechanism, which is already installed on the mobile radio device for other reasons. Furthermore, the decoding of the text message may include an automatic detection of a hyperlink within the text message and an interpretation of this hyperlink in order to thereby extract the information. Once again, the method according to an example embodiment of the present invention for receiving with the aid of hyperlink technology and a standard communications mechanism has the advantage of using established mechanisms, so that the realization is simplified.

An example embodiment of the present invention could also be realized in the form of a mobile radio device, this mobile radio device being set up for implementing the method for transmitting according to the present invention for transmitting and/or the method for receiving according to the present invention. In this case the corresponding method according to the invention would be installed on the mobile radio device in the form of an application or several applications (apps).

A device for a vehicle, which includes a control device, also is provided within the scope of example embodiments of the present invention. The controller is designed to receive text messages via a communications device, the text messages in particular being received via a standard communications mechanism. Moreover, the controller is developed to receive and analyze information in the form of a text message in machine-readable form with the aid of the communications device in order to carry out an application of the vehicle as a function of the information. A device according to an example embodiment of the present invention may be set up to additionally acquire information in the text message that is usable by persons and to output it in such a way that the information is comprehended by a person.

The advantages of the device according to example embodiments of the present invention essentially correspond to the advantages of the method according to example embodiments of the present invention that were explained in detail above, so that they will not be repeated here.

The device of example embodiments of the present invention may also be developed for carrying out the method of example embodiments of the present invention. This likewise applies to all example embodiments of the inventive device mentioned in the following text.

Moreover, the controller may be designed to transmit text messages via the communications device. In this case the device may be able to store the information as text messages in machine-readable form and to transmit the text message to another vehicle, for instance, with the aid of the communications device.

In this example embodiment of the present invention, the device not only is able to receive a corresponding text message and to execute the corresponding application of the vehicle as a function thereof, but is moreover able to set up and transmit the corresponding text message itself, so that a further vehicle likewise equipped with the device according to example embodiments of the present invention is able to automatically start a corresponding application upon receipt of the text message.

In example embodiments according to the present invention:
The device itself includes the communications device and thus is able to communicate with another mobile radio device on its own (for instance in another vehicle).
According to an example embodiment, the device is developed to couple itself to the communications device (e.g., a mobile radio device situated in the vehicle) in terms of communications technology and to transmit and receive the text messages with the aid of this communications device. The link between the device and the communications device may be implemented in a wire-bound or wireless manner (e.g., Bluetooth).

In an example embodiment, the generation of the text message including the corresponding encoding of the information in the text message (e.g., in the form of a hyperlink contained in the text message) may be carried out by the mobile radio device (via an application running on the mobile device), so that the controller transmits only the information to the mobile radio device in such a case (compare the method for transmitting according to the present invention). Moreover, it is also possible that the mobile radio device decodes or interprets the text message also when receiving the text message (by an application running on the mobile radio device), in particular in order to extract the information from the hyperlink. In this case the controller receives only the information from the mobile radio device (compare the method for receiving according to example embodiments of the present invention).

In other words, the present invention according to example embodiments may be realized also in the form of a system which includes a mobile radio device in addition to the device according to example embodiments of the present invention. The method for transmitting according to the invention and the method for receiving according to example embodiments of the invention may then run on this mobile radio device as application(s).

The controller in particular is designed to induce a state change of the vehicle (especially a change in a configuration or setting of the vehicle or a device (such as an air-conditioning system, engine control, transmission) of the vehicle) as a function of the information (by executing the application).

The change in a state of the vehicle may be understood as the change in a random visible or invisible status of the vehicle (for instance the change in a state that varies the driving behavior of the vehicle). Examples of a corresponding state which is changed by the execution of the application are: open or close the sunroof of the vehicle, sport mode of the vehicle on or off, setting the setpoint speed of the cruise control of the vehicle, setting the current destination of the navigation system, etc.

In addition, the controller may be configured to acquire vehicle data of the vehicle and/or data of a driving operation of the vehicle and to transmit it as the information in the form of the text message. The controller is furthermore developed to receive and analyze as information vehicle data of a further vehicle and/or data in connection with a driving operation of the further vehicle.

Vehicle data are, among others, all data relating to the vehicle, such as setting data and configuration data for configuring or adjusting the vehicle or a device (for instance the navigation system, infotainment system, air-conditioning system, sunroof) of the vehicle. The data relating to the driving of the vehicle, for example, include the current location of the vehicle, the destination of the route on which the vehicle is traveling, which was predefined for the navigation system, as well as locations of interest along the route on which the vehicle is traveling.

More specifically, the controller is developed to encode the information in the form of a hyperlink and to embed this hyperlink in the text message.

The following example embodiments exist in the use of hyperlinks:
The information is stored in the form of a data set, the actual hyperlink providing a reference to this data set. In this example embodiment the data set may be located on an external server, for example.
The information is stored directly in the hyperlink, especially in a URL (uniform resource locator).

Although both example embodiments of the hyperlink are optional, an example embodiment in which the information itself is stored directly in the hyperlink advantageously does not have to rely on further external data sources.

In particular, if certain applications of the vehicle that run on the mobile radio device are registered to certain hyperlink types (pseudo-protocols), it is possible to use the hyperlink to start the corresponding application that is registered for the type of the hyperlink, for instance by selecting (clicking) the hyperlink. The hyperlink and the information encoded therein are then able to be analyzed by this application.

For example, an application of the vehicle named CarControl is able to register to the pseudo-protocol “car”. If the text message now received by the device of an example embodiment of the present invention by SMS or email includes the URL “car://blink?time=10&frequency=2”, the device of an example embodiment of the present invention when analyzing the text message starts the application CarControl registered for this protocol because of the keyword “car” and supplies this application with the URL as parameter. The application CarControl analyzes (parses) the URL and then initiates blinking of the vehicle for ten seconds at a frequency of 2 Hz.

When registering an application to a specific pseudo-protocol, a standard mechanism of the API (application programming interface or program interface) of the mobile radio device is used, in particular. As soon as a hyperlink is detected in a text message (e.g., in an email, SMS, Whats-App message) in a standard message app, and an application is registered for the protocol used in the hyperlink, this application is started by the operating system of the mobile radio device when the hyperlink is selected or clicked.

Another example would be the transmission of a hyperlink/URL “car://setmode?sport=1”, which could have the result on the recipient's side that the vehicle of the recipient is switched to a sport mode.

The storing of the information in the form of a hyperlink thus offers the possibility of automatically starting any use or application of the vehicle (in particular with the aid of a mobile radio device on which this application is running and which transmits corresponding control commands to the vehicle) using any set of parameters that is stored in the hyperlink as well. This makes it possible to automatically implement any configuration setting of the vehicle or a device of the vehicle as a function of the received text message, without the person (in particular the driver) having to implement the text message in some manner, as required in the related art.

Although the direct storing of the information in the hyperlink is preferred, it is also possible in an example embodiment of the present invention to store only an identification in the text message as information and to store additional information under this identification in a web service, from where it is then able to be called up by the device of an example embodiment of the present invention upon receipt of the text message using the identification number included in the text message. This identification in particular is an unambiguous designation (e.g., an identification number or an identification string), which can be encoded in a hyperlink and under which the information is then able to be retrieved.

According to an example embodiment of the present invention, the device includes an output device in order to output an additional piece of information which may likewise be included in the text message, to a vehicle occupant, and an input device in order to detect a response of the occupant. The controller is designed to offer an execution of the application via the output device and to execute the application only if the controller has previously detected a positive confirmation in response of the execution offer via the input device.

In this example embodiment, the information transmitted to the vehicle in the form of a text message is first indicated to the driver of the vehicle, such as in the form of the further piece of information. The vehicle driver is then able to decide whether he/she is interested in executing the application that corresponds to the information. If the driver decides in favor of the execution of the application, then the application will be started virtually on the basis of parameters that are automatically retrieved from the information. In an advantageous manner, no manual input of these parameters by the driver is necessary as a result.

According to an example embodiment of the present invention is it also possible to use the mobile radio device as output device and input device. In this case the further information is extracted from the text message by the mobile radio device and displayed. The response, too, is detected by the mobile radio device and analyzed. The mobile radio device is designed to offer the execution of the application and to execute the application only if the mobile radio device has previously detected a positive confirmation in response of the execution offer. In this case, the mobile radio device on which a corresponding application is running transmits corresponding control commands to the controller in case of a positive confirmation. Accordingly, this involves example embodiments of the different methods according to the present invention as well.

A website may be used for realizing a conditioned display with the aid of the output device in order to indicate the information contained in the text message to a user. This is virtually an alternative to starting an application with the aid of the hyperlink. In this alternative, the corresponding link would be shown in the form of a website, for instance, to which the information to be displayed is transmitted by parameters.

According to an example embodiment of the present invention, the device includes an infotainment system. The controller is designed to store the information in the infotainment system when the application is executed.

This example embodiment, for example, makes it possible for the driver of a further vehicle to transmit a radio station or a certain music title to the vehicle as information. The information is automatically stored in the infotainment system of the vehicle, so that the driver of the vehicle automatically is able to listen to the same radio station or the same music title as the driver of the further vehicle (depending on a yes/no confirmation).

Example embodiments of the present invention expand the principle of the transmission of certain vehicle states from one vehicle to another vehicle. Mobile radio devices coupled to the individual vehicle may be used to realize the communication between the vehicles via different standard message services. Since the transmitted text message (also) includes machine-readable information, the device according to example embodiments of the present invention inside the receiving vehicle is able to automatically process this information further (without manual implementation).

Quite different communication channels and/or communications mechanisms may be used for example embodiments of the present invention. If the text message is received or transmitted via a mobile radio device in example embodiments the present invention, the invention may be used without modification also for future communications mechanisms which are then to be supported by the mobile radio device. In this case it is the user who can decide which communications mechanism to use in order to transmit or receive a text message.

Example embodiments of the present invention is particularly suitable for use in motor vehicles. Of course, the invention is not restricted to this preferred application field, since it is also usable on ships, airplanes as well as in vehicles that are rail-bound or track-guided.

In addition, the present invention is not restricted to means of locomotion. For example, the text message can be transmitted by any (also stationary) service provider. The transmitted text messages also need not necessarily address precisely one recipient, but could be transmitted by broadcast/multicast to a group of recipients as well, provided the utilized communications channel allows this.

The principle according to example embodiments of the present invention may also be used for the communication between entertainment electronics devices in the home. For example, a television may be linked to a mobile device. Via an application running on the mobile radio device, another mobile radio device, which is likewise linked to a television, may be informed about the current program, for example with the aid of a standard message service. Following a corresponding confirmation, the receiving mobile radio device is now able to instruct the television set to which it is linked to switch to the transmitted program. Similar application examples are conceivable for satellite receivers, radios and streaming clients.

The following examples of use are possible as a result:
A business informs about a special sale at a certain chain store, for instance via subscribable tweets, and stores the route information of this store in the transmitted text message; if desired, this route is then able to be imported, for instance by the receiving mobile radio unit, as destination into the navigation system of the vehicle coupled to the mobile radio device.
A weather service informs about freezing temperatures in the coming night and stores in the text message the option to activate the auxiliary heater of the vehicle at a specific time the next morning.

In addition, it is possible to store the information directly on a website, which results in the following application options:
A manual of a certain vehicle is offered on a website and includes the option of directly testing individual functionalities of the vehicle described in the manual by selecting the corresponding information in the form of a hyperlink, for example.
A website has information about certain points of interest, and for every point of interest the option is offered to select a navigation destination that corresponds to the point of interest, for instance in the form of a hyperlink, and to thereby automatically load the navigation destination into the navigation system of the vehicle.

Further features and aspects of example embodiments of the present invention are explained in detail below with reference to the appended Figures.

### BRIEF DESCRIPTION OF THE DRAWINGS

FIG. 1 shows the transmission of a text message from one vehicle to another vehicle according to an example embodiment of the present invention.

FIG. 2 shows the transmitting and receiving of a text message on the basis of two example embodiments of the present invention.

FIG. 3 schematically illustrates a vehicle according to an example embodiment of the present invention which includes an inventive device.

### DETAILED DESCRIPTION

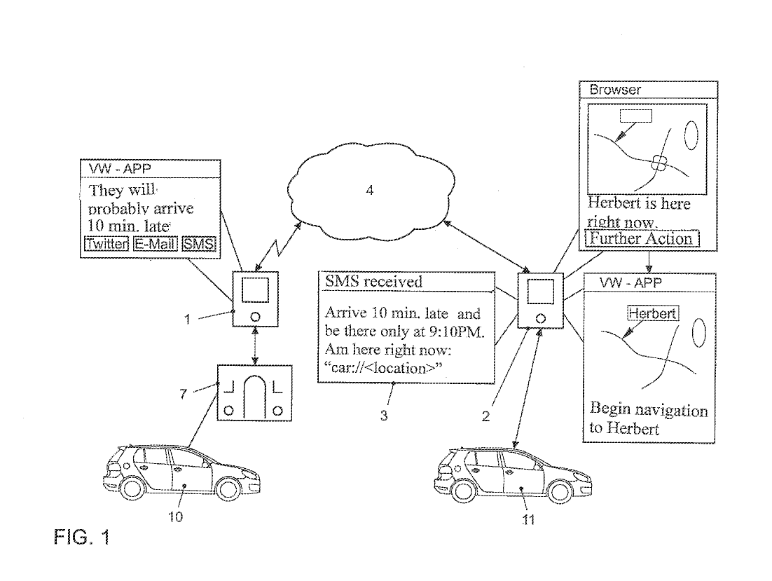

Vehicle 10 according to an example embodiment of the present invention shown in FIG. 1 includes an infotainment system 7, which is coupled to a mobile radio device 1. For communication purposes, mobile radio device 1 is linked to infotainment system 7, for instance via Bluetooth, WLAN or cable, so that data can be exchanged between infotainment system 7 and mobile radio device 1.

Instead of the infotainment system, the link between the vehicle or a component of the vehicle and the mobile radio device could also be realized via a separate hands free telephone device of the vehicle or a communications linkage device (e.g., a plug-in connection) to the mobile radio device in an armrest of the vehicle.

An application of mobile radio device 1 now makes it possible to convert certain data, such as arrival time, congestion information, remaining distance, destination and vehicle position, which are supplied by the infotainment system, into a text message. The application then provides the option to transmit this text message via different standardized communications mechanisms by way of mobile radio network 4. For example, this makes it possible to transmit the message “I will be arriving 10 minutes late and be there at 9:10 PM only. I am currently here car://<location>”, in that the user or driver simply pushes the appropriate button on his or her mobile radio device 1. In other words, text message 3 itself together with the location encoded as hyperlink or URL (current position of transmitting vehicle 10) is automatically generated from the corresponding data of infotainment system 7.

This text message 3 is received by mobile radio device 2. The text message is then displayed in the usual application of mobile radio device 2 for the selected communications mechanism (e.g., WhatsApp). The hyperlink is highlighted in the displayed text, provided an application is registered for the appropriate protocol on the receiving mobile radio device 2. If the user clicks on this hyperlink, this application, which may be a special application of the vehicle manufacturer, or a web browser, will be started. The information stored in the hyperlink is detected and analyzed by the application or the web browser. For example, a certain position transmitted in the text message may be displayed on a map.

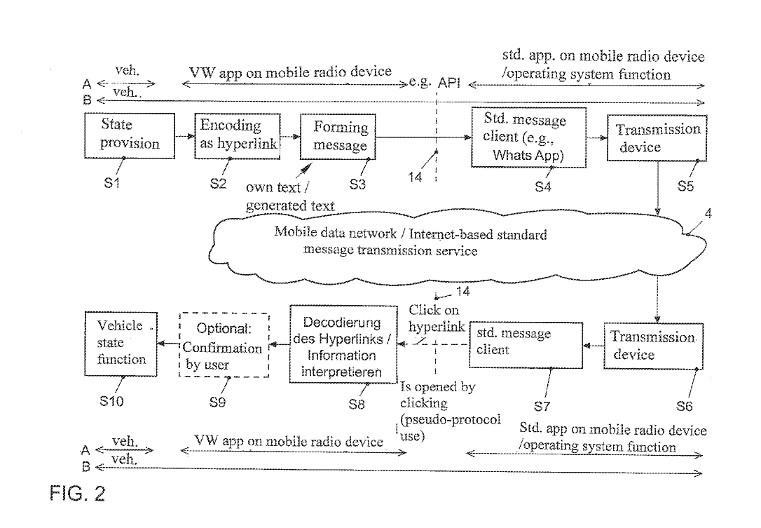

In FIG. 2, a certain state or a certain piece of information of a vehicle is made available in a first step S1. This state or this information, for instance, may be vehicle data (i.e., data stored inside the vehicle) or also driving data. This information is encoded as hyperlink in second step S2, which will then be embedded in a text message in third step S3. The text message may be generated completely or partially in an automatic manner, but may also include portions of a manually prepared text. In the first variant A, steps S2 and S3 are executed by a special application, which is running on a mobile radio device. In second variant B, on the other hand, steps S2 and S3 are implemented by the device according to the invention.

In variant A, a program interface 14 is used to forward the text message in step S4 to an application which realizes a standardized message service (e.g., WhatsApp). In step S5, the text message is transmitted with the aid of the standardized message service and a transmission device (of the mobile radio device or the device). While steps S4 and S5 are implemented by a standardized application of the mobile radio device or an operating system functionality of the mobile radio device in variant A, steps S4 and S5 of variant B are executed by the device according to example embodiments of the present invention.

Via a mobile radio network 4 or an Internet-based standardized message transmission service, the text message is transmitted to a mobile radio device inside a further vehicle (variant A) or to a device according to the present invention in a further vehicle (variant B), where it is received by the corresponding transmission device (of the mobile radio device or the device) in step S6. In step S7, the text message with the hyperlink is displayed with the aid of an application which realizes the standardized message service. Once again, steps S6 and S7 are implemented by a standardized application of the mobile radio device or an operating system functionality of the mobile radio device in variant A, while steps S6 and S7 of variant B are executed by the device according to example embodiments of the present invention.

By clicking on the hyperlink, an application identified by the hyperlink (e.g., by applying the pseudo-protocol) is started in step S8; it decodes the hyperlink and interprets a piece of information represented by the hyperlink. Following a confirmation (step S9) by the user (in particular the driver of the vehicle), a state of the vehicle is optionally modified or a functionality of the vehicle is activated as a function of the information. In variant A, steps S8 and S9 are implemented by a special application, which is running on a mobile radio device. In the case of variant B, on the other hand, steps S8 and S9 are carried out by the device according to an example embodiment of the present invention. In variant B, the activation of the hyperlink, and thus the starting of the application identified by the hyperlink, may also take place automatically (without a user having to click).

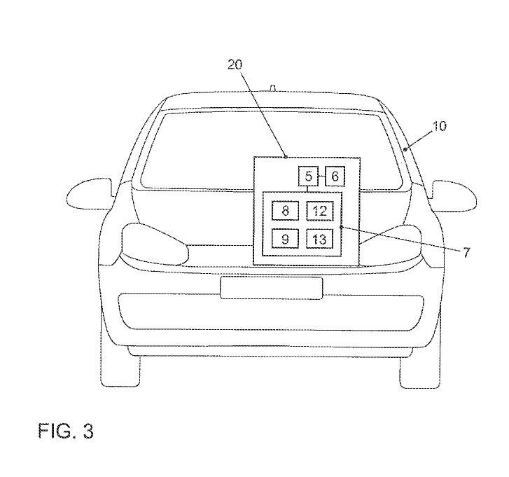

FIG. 3 shows a vehicle 10 according to an example embodiment of the present invention, which includes an inventive device 20. Device 20 according to an example embodiment of the present invention in turn includes a controller 5, a communications device 6, and an infotainment system 7. The infotainment system encompasses an input device 8, an output device 9, a navigation system 12, and a radio 13.

### LIST OF REFERENCE NUMERALS

1, 2 mobile device
3 SMS
4 mobile radio network
5 controller
6 communications device
7 infotainment system
8 input device
9 output device
10, 11 vehicle
12 navigation system
13 radio
14 program interface
20 device
Sx method step

1-14. (canceled)

15. A method for communication between a transmitter and a vehicle, the method comprising:
transmitting information in the form of a text message in machine-readable form from the transmitter to the vehicle;
receiving the information of the vehicle;
analyzing the information of the vehicle; and
automatically executing an application of the vehicle as a function of the information.

16. The method as recited in claim 15,
wherein the information includes a location stored in a navigation system of the vehicle; and
wherein a route for the vehicle is determined as a function of the location.

17. The method as recited in claim 16,
wherein the information includes a station identification; and
wherein a radio station that corresponds to the transmitter information is turned on in a radio of the vehicle.

18. A method for transmitting information of a vehicle, the method comprising:
detecting a piece of information of the vehicle;
encoding the information in machine-readable form into a text message; and
transmitting the information by mobile radio communication.

19. The method as recited in claim 18, wherein the encoding of the information into the text message includes encoding the information in the form of a hyperlink, and embedding the hyperlink in the text message.

20. The method as recited in claim 18, wherein the transmission of the text message is implemented by a standard communications mechanism via a mobile radio network.

21. A method for receiving information for a vehicle, the method comprising:
receiving a text message via mobile radio communication;
decoding the text message in order to acquire the information within the text message; and
transmitting the information to the vehicle in order to execute an application of the vehicle as a function of the information.

22. The method as recited in claim 21, wherein the receiving of the text message is implemented by a standard communications mechanism via a mobile radio network.

23. The method as recited in claim 21, wherein the decoding of the text message includes an extraction of a hyperlink within the text message and an interpretation of the hyperlink.

24. A device for a vehicle, comprising:
a controller configured to:
receive text messages via a communications device,
receive and analyze information in the form of a text message in machine-readable form with the aid of the communications device, and
carry out an application of the vehicle as a function of the information.

25. The device as recited in claim 24, wherein the controller is further configured to:
transmit text messages via the communications device,
transmit the information in the form of the text message in machine-readable form with the aid of the communications device.

26. The device as recited in claim 24, wherein the controller is further configured to induce a state change of the vehicle by executing the application.

27. The device as recited in claim 24,
wherein the controller is further configured to
acquire at least one of (i) vehicle data of the vehicle, and/or (ii) data in connection with a driving operation of the vehicle, and
transmit the at least one of (i) vehicle data of the vehicle, and/or (ii) data in connection with a driving operation of the vehicle as the information in the form of the text message; and
receive and analyze as information the at least one of (i) vehicle data of the vehicle, and/or (ii) data in connection with a driving operation of the vehicle.

28. The device as recited in claim 24, wherein the controller is configured to encode the information in the form of a hyperlink and to embed this hyperlink in the text message.

29. The device as recited in claim 24, further comprising:
an output device; and
an input device;
the controller further configured to offer an execution of the application via the output device and to execute the application only if the controller has detected a positive confirmation via the input device in response of the execution offer.

30. The device as recited in claim 24, further comprising:
an infotainment system;
the controller further configured store the information in the infotainment system when executing the application.
